(19) United States
(12) Patent Application Publication
(10) Pub. No.: US 2004/0174600 A1
(43) Pub. Date: Sep. 9, 2004

(54) Solid-state optical logic

(75) Inventor: Jonathan Westphal, Pocatello, ID (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Jonathan Westphal, Pocatello, ID

(21) Appl. No.: 10/750,373

(22) Filed: Dec. 31, 2003

Related U.S. Application Data
(60) Provisional application No. 60/438,047, filed on Jan. 4, 2003.

(51) Int. Cl. G02B 5/30

(52) U.S. Cl. 359/495

(57) ABSTRACT

An optical element for producing an optical NOR gate uses a pair of spatial light modulators or phase shifters and one or more beam splitters to produce outputs representing respectively an XOR function of two control inputs and a COIN function of the two control inputs. The XOR output and the COIN output are combined with a phase shifted version of the source of light used to generate the XOR and COIN outputs to produce both an optical output representing a logical NOR function of the two control inputs. The same circuitry also produces an optical output representing a logical AND function of the two control inputs. The techniques disclosed permit a complete system of optical logic to be produced that can be used to produce an optical processor. The optical logic can advantageously be used in information processing and in communications.

### CROSS REFERENCE TO RELATED APPLICATIONS

This application is related to and claims priority to provisional patent application 60/438,047, filed Jan. 4, 2003, entitled Solid-State Optical Nor-Gate.

### BACKGROUND OF THE INVENTION

1. Field of the Invention

The solid-state optical logic described in the application relates to the field of optical signal processing and optical computing, especially in telecommunications applications.

2. Description of Related Art

Attempts to implement a logically complete system of optical processing have had difficulty in the past due to two unsolved problems. The first is the non-linear responses of available optical materials. Unlike silicon logic implementations, the optical AND function has been bedeviled by the linearity of intensity sums: there is no intensity threshold which functions as the analog of a PN device. The second is the inherent difficulty of implementing a NOT function which reverses input 1 to 0 and 0 to 1. It is simple enough to create a blocking device which on optical 1 input produces a 0 optical output. But if indeed the optical 1 is the presence of an optical signal, then the optical 0 input must output an optical 1, i.e. the absence of input must result in a positive output. Thus there is to date no solid-state optical implementation of a complete logic system, i.e an optical NOR or NAND function.

### SUMMARY OF THE INVENTION

This invention overcomes a problem of the prior art described above in that it provides complete set of logical functions, using spatial light modulators or phase shifters and beamsplitters to produce optical logic and devices for executing logical functionality.

### BRIEF DESCRIPTION OF THE DRAWINGS

The invention will be described more in detail hereinafter by reference to the following drawings in which:

FIG. 1 is an illustration of optical circuitry utilized in carrying out one aspect of the invention.

FIG. 2 represents an improvement on the invention of FIG. 1 and which constitutes the best mode known at the moment for carrying out the invention.

### DETAILED DESCRIPTION OF THE INVENTION

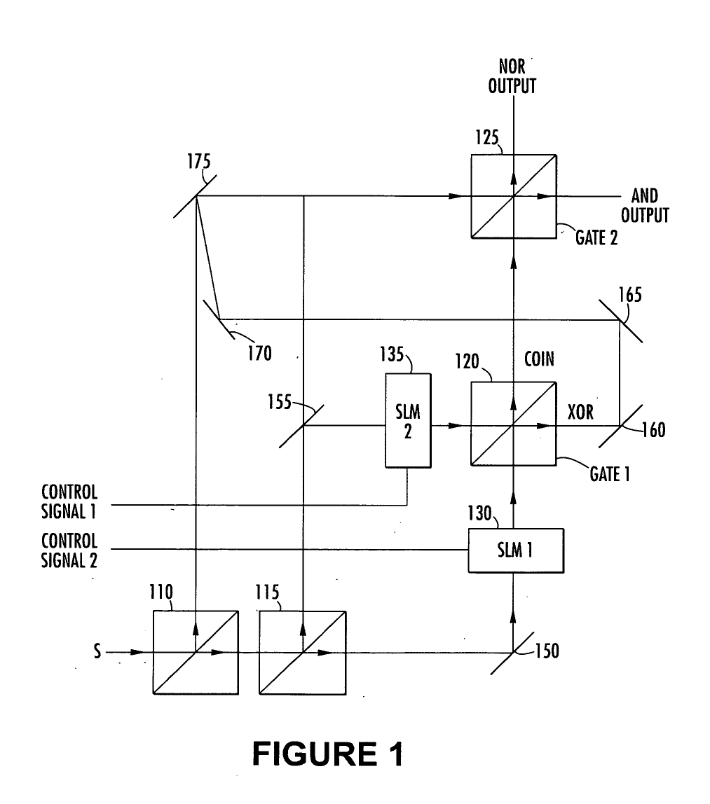

As shown in FIG. 1, a first embodiment of the invention consists of four beamsplitters 110, 115, 120, 125, reflectors 150, 155, 160, 165, 170, 175, and two spatial light modulators (SLMs), 130, 135 or phase modulators. Light enters the device at S, and is split at beamsplitter 110. The two resulting beams are mutually coherent. Light leaving 110 on a easterly track (assuming north points to the top of the page) enters beamsplitter 115). This light is again split into two mutually coherent beams. The reflected beam under goes a phase shift of 180° on reflection. The transmitted beam substantially maintains its phase unchanged. The northerly beam is reflected into Gate 1, the XOR gate, which is beamsplitter 120, passing through an SLM or phase modulator 130. The SLM may be optically or electronically addressed. The SLM or phase modulator selectively reverses the phase of its input beam. The beam exiting 115 in a northerly direction is reflected in to Gate 1, or beamsplitter 120, passing through another SLM (SML2-135) or phase modulator, which selectively reverses the phase of the input, depending on the state of the control signal.

Turning to the operation of FIG. 1 in more detail, if control signal 1 is ON at the input phase modulator 1, but control signal 2 is OFF, the result is that the two beams in 120 combine and exit 120 in an easterly direction. The same is true if control signal 1 is OFF and control signal 2 is ON; a single beam exits the beamsplitter in an easterly direction.

If either control signal 1 and 2 are both ON or both OFF, the result is that the beams input into (c) are mutually coherent, and in both cases a single beam exits (c) in a northerly direction.

Thus the output from the east port of 120 is a logical XOR function. It is ON or 1 iff the input pattern of the two control signals if 10 or 01, otherwise OFF or 0.

The output from the north port of (c) is a logical COIN function. It is ON or 1 iff the input pattern of the two control signals is 11 or 00, otherwise OFF or 0. This means that whenever the two input beams carry the same or coincident (COIN) logic information, or are physically in phase, the output in the north port of (c) is 1.

The purpose of the next optical logic operations in the device is to distinguish the two forms of the northerly COIN output from 120. This COIN output enters gate (2) or beamsplitter 125 and is combined with the half the original input from S, proceeding via 110. If the SLMs or phase modulators have no input from the control signals and register the input pattern 00, then the COIN outputs combine with the original northerly output from 110 and thus from S. The result is that the beams combine in 125 and exit north, giving a NOR output. This can be used as a new control signal.

If on the other hand the control signals into Gate 1, the beamsplitter 120, are both ON, then the COIN beam entering 125 is exactly out of phase with the beam entering 125 from 110 and S. In that case the two beams input into 125 combine and exit in an easterly direction. This beam is ON iff both SLMs or phase modulators in 120 are ON; it produces an AND output. There is a beam exiting north from 125 iff both inputs in to 120 are OFF, i.e. if the phases of the beams into 120 are undisturbed and the same as those entering 125 from S via 110. The northerly output of 125 is ON iff both control signals are OFF. The northerly 125 output is thus the desired NOR function.

The function of the destructive interference at the reflector 175 leading into the west port of 125 is to prevent light from S entering 125 when the XOR output of 120 is ON, i.e. when the COIN output of 125 is supposed to be OFF. There must be a destructive interference of the unwanted S beam by the XOR output from 120 when the COIN function is in the OFF or 0 state.

All other logical functions can be constructed from the NOR elements, and thus all computable functions can be computed by arrays of the NOR-gate described. In this respect the described NOR-gate is the optical equivalent of the silicon AND or NOR gates. It consists only of optical components, and can be operated without ensuring mutually coherent light sources, as there is a single source S. The final output beam at the NOR OUTPUT derives from S in an unimpeded run through the device. The only speed limitation on a positive throughput signal is the speed with which the light travels through the device down the two arms from S to the NOR OUTPUT.

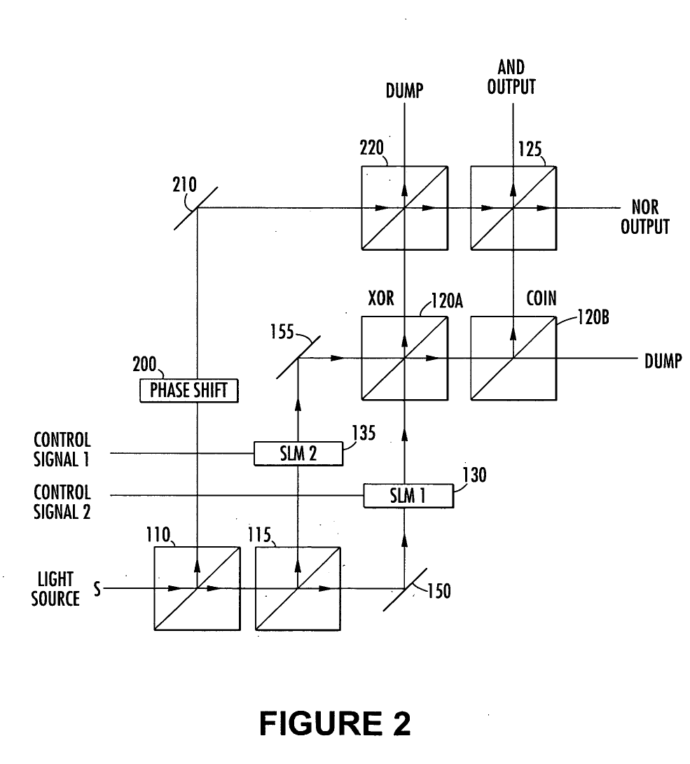

FIG. 2 of the drawings represents an improved version of the invention shown in FIG. 1. When working with the invention as described in FIG. 1, it became apparent that one could not achieve extinction of the beams as completely as one might desire in particularly in the destructive interference process occurring at a reflector 175 of FIG. 1. FIG. 2 represents an improved configuration over that shown in FIG. 1, which results in improved extinction and improved signal quality over that shown in FIG. 1.

Beamsplitters 110 and 115, reflector 150, spatial light modulators 130, 135, reflector 155 and beamsplitter 125 function substantially is outlined in conjunction with FIG. 1. A phase shifter 200, is placed in the path of the light beam exiting beamsplitter 110 on a northerly direction and the subsequent reflector 210. Beamsplitters 120 (a) labeled XOR and 120 (b) labeled COIN provide the functionality associated with beamsplitter 120 in the embodiment shown in FIG. 1.

The embodiment shown in FIG. 2 differs from that in FIG. 1 in that separate beamsplitters are utilized to generate the XOR output and the COIN output. This allows a certain parallelism that permits more complete cancellation of signals over the configuration shown in FIG. 1. The respective XOR and COIN outputs are combined in beamsplitter 125 (after the XOR output passes through beamsplitter 220) to produce a NOR output on the easterly output of beamsplitter 125 and to produce an AND output on the northerly output of beamsplitter 125.

This embodiment is preferred because it requires less adjustment of reflectors and achieves more complete cancellation of light beams resulting in cleaner output signals, and balances the power on both arms of the interferometric paths.

Using the techniques described herein one can generate a complete set of optical devices that can be utilized to implement completely optical logic which can be utilized in a wide array of devices. For example, logic for computer systems can be enhanced and hardened against certain types of interference utilizing the optical devices described herein. Communication devices, interfaces and circuits can also be generated utilizing the techniques described herein. The result will be faster and more reliable on computers, processors and communication devices.

The optical device of FIG. 2 uses wave retardation and beamsplitters to create a NOR-gate.

Let two orthogonal and mutually coherent beams enter a beamsplitter 120A from the west (W) and from the south (S) representing respectively vectors p and q. The axis of the beamslitter is orthogonal to the XOR, or p\overline{q} v \overline{p}q, axis. The two possible outputs are XOR and its dual COIN.

If one of the two input beams is delayed by a phase shifter, or for parallel operations a spatital light modulator (SLM), activated by an optical or electronic control signal, then one of the possible outputs beams [say to the north (N)] will possess an XOR functionality.

If both or neither beams are delayed, we have the dual COIN output, traveling east from 120A.

The truth-table for the COIN function is:

| p | q | pCOINq |
|---|---|---|
| T | T | T |
| T | F | F |
| F | T | F |
| F | F | T |

We notice that the vector pq v \overline{pq} would be equivalent to \overline{p} \overline{q} if we could delete the disjunct pq. In FIG. 1 we achieve this result optically by bringing the COIN output from beamsplitter 120 as input, with the second input into 125 being a reference beam from the original source. The light exiting beamsplitter 125 east (E) is ON if and only if the two control signals on beamsplitter A are OFF.

Although the exemplary embodiments have been disclosed herein, the scope of the invention is not limited thereto but rather is expressed in the claims set forth hereinafter.

What is claimed:

1. A optical element comprising:
a. two control inputs,
b. an optical processing arrangement for producing an optical output that corresponds to a logical NOR function of the two control inputs.

2. The optical element of claim 1 in which the control inputs are optical inputs.

3. The optical element of claim 1 in which the control inputs are electrical inputs.

4. The optical element of claim 1 in which a single light source is used in conjunction with the two control inputs to produce said optical output.

5. The optical element of claim 1 in which the optical processing arrangement comprises at least one combination of optical elements producing respective XOR and COIN function outputs of the two control inputs which function outputs are used in producing a logical NOR function of the two control inputs.

6. The optical element of claim 5 in which the at least one combination of optical elements comprises at least one spatial light modulator.

7. The optical element of claim 6 in which the at least one combination of optical elements comprises at least one beam splitter.

8. The optical element of claim 5 in which the at least one combination of optical elements comprises at least one phase modulator.

9. The optical element of claim 8 in which the at least one combination of optical elements comprises at least one beam splitter.

10. The optical element of claim 5 in which the at least one combination of optical elements producing respective XOR and COIN function outputs of the two control inputs comprises two beam splitters with one producing an XOR function output and one producing a COIN function output.

11. The optical element of claim 5 further comprising an optical arrangement comprising at least one beam splitter for combining the XOR function output with the COIN function output to produce an optical output that corresponds to a logical NOR function of the two control inputs.

12. The optical element of claim 11 in which the XOR function output and the COIN function output are combined with a phase shifted version of the same light source used to produce the XOR and COIN function outputs to produce a logical NOR function of the two control inputs.

13. The optical element of claim 11 in which the optical arrangement comprising at least one beam splitter also produces a logical AND function of the two control inputs.

14. An information processing system comprising a plurality of optical elements, at least one of which comprises an optical NOR gate.

15. The information processing system of claim 14 in which the plurality of optical elements comprises an optical processor.

16. The information processing system of claim 14 in which the optical processor comprises an optical NOR gate.

17. An communication system comprising a plurality of optical elements, at least one of which comprises an optical NOR gate.
